(19) United States
(12) Patent Application Publication
(10) Pub. No.: US 2013/0043098 A1
(43) Pub. Date: Feb. 21, 2013

(54) LIFT INSTALLATION WITH LIFT CAGE WITH YIELDING ROOF CONSTRUCTION

(71) Applicants: Peter Baltisser, Zuzwil (CH); Eric Kertész, Riehen (CH)

(72) Inventors: Peter Baltisser, Zuzwil (CH); Eric Kertész, Riehen (CH)

(21) Appl. No.: 13/587,963

(22) Filed: Aug. 17, 2012

(30) Foreign Application Priority Data
Aug. 18, 2011 (EP) 11177907.0

(51) Int. Cl. B66B 11/02

(52) U.S. Cl. 187/401

(57) ABSTRACT

The invention relates to a lift installation with a cage (1) and a cage roof (2) and at least one cage roof part (3), which is suspended indirectly or directly at the cage roof frame (2) by means of at least one retaining element (4) and covers an opening of the cage roof (2). The retaining element (4) exerts on the cage roof part (3) a magnetic force which is at least equal to the weight force of the cage roof part (3).

### FIELD

The present invention relates to lift installation with a lift cage, which has a yielding roof construction.

### BACKGROUND

In the design of a lift installation a high priority is attached to the optimum utilisation of space. Accordingly, it is sought to keep the free shaft space at the upper shaft end above the cage as small as possible. The cage roof can normally be walked on for the purpose of maintenance and service operations. In order to prevent a person from being crushed between cage roof and shaft head, safety standards demand, inter alia, a protective space of 0.6×0.8×0.5 cubic metres. This means nothing more than that the spacing between the maintenance area on the cage roof and the shaft head on an area of 0.6×0.8 square metres must not be less than 0.5 metres when the cage is located in the uppermost reachable position.

WO 2008/074168 A1 shows a cage construction by which the spacing between the cage and the upper shaft end is reduced to below 0.5 metres. For this purpose the case roof is designed to be yielding on a plan area of at least 0.6×0.8 square metres. This cage roof has a cage roof part which is connected with the rest of the cage roof by way of a perforated frangible edge. This frangible edge is in that case so dimensioned that when walking onto the cage roof part the frangible edge breaks and the cage roof part thereby drops into the interior space of the cage. The safety space is thereby at least partly shifted into the interior space of the cage. Consequently, the safety standards are fulfilled even in the case of falling below the safety spacing of 0.5 metres between the cage and the upper shaft end.

However, in this concept the permanent damage of the cage roof has a negative influence, because once the frangible edge is broken once the cage roof has to be replaced. These repair operations are relatively complicated and costly. In addition, these operations lead to a lengthy out-of-service state of the lift installation.

### SUMMARY

Accordingly, the present invention has the object of developing a lift installation with reduced shaft head space which is as simple and efficient as possible in maintenance.

According to a first aspect the lift installation comprises a cage and a cage roof, which comprises at least a cage roof part. The cage roof part is suspended by means of at least one retaining element and covers an opening of the cage roof. The lift installation is distinguished by the fact that the retaining element exerts a magnetic force on the cage roof part. This magnetic force is at least equal to the weight force of the cage roof part.

By weight force there is understood here the gravitational force m*g. This gravitational force includes all weight forces of elements which are arranged at the cage roof part and are carried at least partly by the retaining element.

In addition, the magnetic force exerted by the retaining element is preferably designed so that it is at least equal to the weight force as well as an operating force acting on the cage roof part. By operating force there is understood here, for example, an acceleration force which arises during acceleration or deceleration of the cage and which in operation of the lift installation acts on the cage roof part additionally to the weight force.

The advantage of such a lift installation resides in the simple mounting of the cage roof part by way of retaining elements. The retaining elements are in that case arranged at the cage roof and retain the cage roof part at the cage roof by means of a magnetic force. The cage roof part can thus be fastened to the cage roof in merely one working step in that the cage roof part is held up to the retaining elements.

In a further aspect the retaining element forms a releasable connection between the cage roof and the cage roof part. In that case, the connection releases from a predeterminable critical release force which acts on the cage roof part from above the cage roof.

The precise and selectable setting of the critical release force up to which the cage roof part is fixed to the cage roof is particularly advantageous. The number of retaining elements is freely selectable and settable to a specific critical release force at which the connection releases. In addition, the critical release force can be varied by means of retaining elements of different magnetic force.

The critical release force is so set that when walking onto the cage roof part the connection between the cage roof part and the cage roof reliably releases. This is the case in a weight force range of approximately 100 to 300 N.

A further aspect relates to a multi-part construction of the cage roof part. With increasing plan area of the cage roof part the reliability in the case of release of the connection between the cage roof part and the cage roof can be prejudiced, because, when there is a large plan area with widely spaced-apart retaining elements and a locally acting weight force of a person who has walked on, the retaining elements are loaded very unequally. Tests have shown that cage roof parts from a plan area of 2 square metres are preferably of two-part design. In the case of even larger plan areas the cage roof part can also be of three-part construction or, if required, constructed from even more part members.

A multi-part design of the cage roof part has the advantage that the weight force of a person stepping onto it is distributed substantially uniformly to the retaining elements and thus when the critical retaining force is exceeded all connections at the retaining elements are reliably released.

The retaining element is preferably designed as a magnetic strip or as a magnetic element.

In the case of use of magnetic strips at least two magnetic strips are mounted on the cage roof on opposite sides of the cage roof part. It is also possible to arrange four magnetic strips on the cage roof on all four sides of the cage roof part.

The magnetic elements are typically conventional cylindrical elements, square elements or rectangular elements. Depending on the respective size and magnetic strength of the magnetic elements several of these elements are arranged on the cage roof along the side edges of the cage roof part. In that case the magnetic elements are preferably equidistantly spaced apart.

In a further aspect a retaining element is arranged at the cage roof to be adjustable in height by means of a setting element. The setting element is preferably designed as a setting screw. The retaining element is in that case suspended at the cage roof by means of the setting element. The height of the retaining element relative to the cage roof can thus be regulated. Apart from setting screws, pins which are fixable to the cage roof at a different height by way of a detent or clamping mechanism, are also usable as setting elements.

The advantage of setting the height of the retaining elements resides in the fact that the retaining elements can be set so that they form an ideal contact surface with the cage roof part without, as far as possible, tipping. A defined action of a magnetic force of a retaining element on the cage roof part is thus guaranteed.

A further aspect relates to a safety element which connects the cage roof part with the cage roof. The safety element holds the cage roof part at a predeterminable minimum height relative to the cage interior space after release of the connection. The safety element is preferably designed as a belt, rope, cable or the like.

Optionally, use can also be made of two or more safety elements. Particularly in the case of a multi-part embodiment of the cage roof part each individual part is secured by at least one safety element. In a further preferred embodiment the cage roof part or each individual part is secured by two or more safety elements.

In that case, there is the advantageous result that the cage roof part does not fall uncontrolled into the interior space of the cage. This prevents possible injuries to a person, who presses in the cage roof part, and to the cage occupants.

In addition, a catch net is optionally so arranged on the cage roof part that by means of this a person stepping onto the cage roof part can be caught and prevented from a fall into the cage.

### DESCRIPTION OF THE DRAWINGS

The invention is clarified and further described in the following by embodiments and by way of drawings, in which:

FIG. 1a shows a first embodiment of the cage roof with yielding cage roof part in a side view;

FIG. 1b shows the first embodiment of the cage roof with yielding cage roof part in a plan view;

FIG. 2a shows a second embodiment of the cage roof with yielding cage roof part and safety straps in a side view;

FIG. 2b shows the second embodiment of the cage roof with yielding cage roof part and safety straps in a plan view; and

FIG. 3 shows a detailed view of a suspension of the retaining element with setting screw for height adjustment of the retaining element.

### DETAILED DESCRIPTION

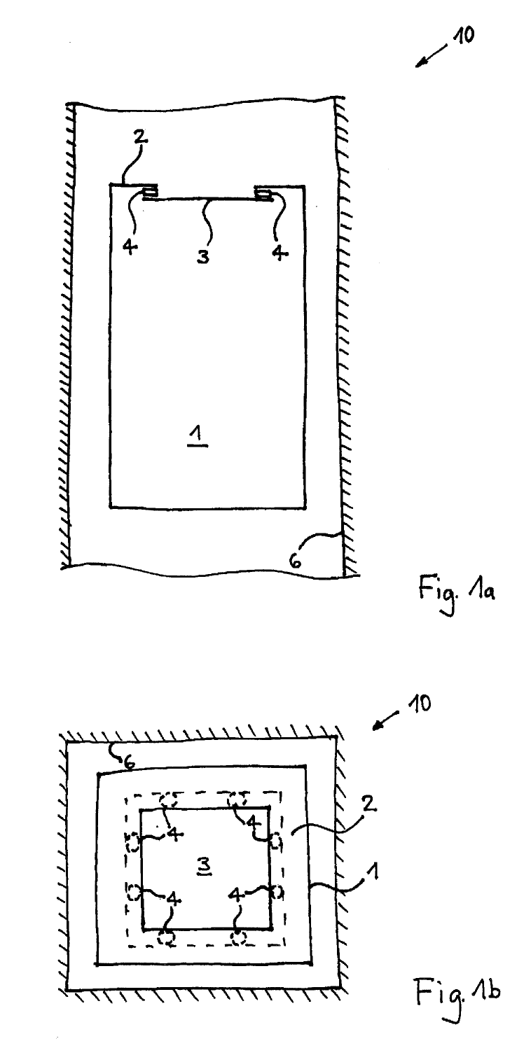

FIGS. 1 a and 1 b shows a lift installation 10 with a cage 1. The cage 1 is movable in a shaft 6 along guide rails. For that purpose the lift installation typically has a counterweight, a supporting and driving means at which the cage 1 and the counterweight are suspended, and a drive unit, which is in operative connection with the supporting and driving means by way of a drive pulley. For reasons of clarity, guide rails, counterweight, supporting and driving means and the drive unit are not illustrated in FIGS. 1a and 1b.

The cage 1 is bounded in upward direction by a cage roof 2. The cage roof 2 has a region which is design to be yielding. For that purpose, provided in the cage roof 2 is an opening which is coverable by a cage roof part 3. Advantageously, the plan area of the cage roof part 3 is greater than the plan area of the opening in the cage roof 2. Correspondingly, there is an overlap region in the edge region of the cage roof part 3 with the region of the cage roof 2 bounding the opening. In that case, the cage roof part 3 is arranged below the cage roof 2. It is thus ensured that when the cage roof part 3 is walked on this is lowered into the interior space of the cage 1 and the available safety space with respect to the upper shaft end is increased.

The cage roof part 3 is, in the illustrated embodiment, fixed to the cage roof 2 by means of eight retaining elements 4, namely two per side of the cage roof part 3. The retaining elements 4 are suspended at the cage roof 2 in the overlap region with respect to the cage roof part 3.

The retaining elements 4 are formed as elements which exert a magnetic force on the cage roof part. Suitable for that purpose are, in particular, conventional magnetic elements of cylindrical or rectangular design. Alternatively thereto magnetic strips are also usable. The number of magnetic elements used and the magnetic force of an individual magnetic element are to be designed with reference to the side lengths of the cage roof part 3 and the weight force of the cage roof part 3 and the operating forces acting thereon.

The total force of the magnetic force of all retaining elements 4 which fix the cage roof part 3 to the cage roof 2 is so dimensioned that this total force is at least as equal to the weight force of the cage roof part 3. In a particularly preferred embodiment the total force is at least equal to the weight force and the operating forces acting on the cage roof part 3. It is thus ensured that the cage roof part 3 in operation of the lift installation reliably remains arranged at the cage roof 2. In addition, the total force of all magnetic forces is not to exceed a critical release force of 300 N, so that the connections of the retaining elements 4 when the cage roof part 3 is walked on release and the cage roof part 3 drops into the interior space of the cage 1.

In the illustrated embodiment of FIGS. 1a and 1b two retaining elements 4 are provided on each side in order to keep the cage roof part 3 at the cage roof. In departure therefrom a greater or smaller number of retaining elements 4 on each side of the cage roof part 3 is also usable.

In the case of retaining elements 4 designed as a magnetic strip one retaining element 4 per side is preferably usable. In that case, the magnetic strip typically has approximately the same length as a side length of the cage roof part 3.

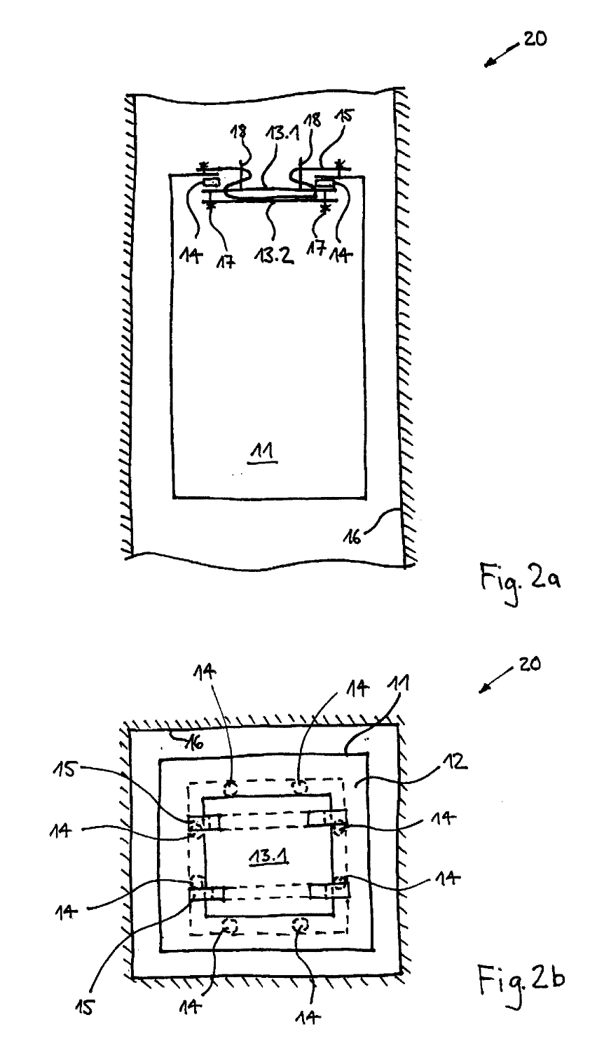

FIGS. 2a and 2b show a further embodiment of the lift installation 20 with a cage 11 movable in a shaft 16. By contrast to the embodiment of FIGS. 1a and 1b, the lift installation 20 here has a safety element 15. The safety element 15 is preferably constructed as a rope, cable, strap or the like.

In the embodiment illustrated here the safety element 15 is designed as a strap. According to FIG. 2b, two such safety elements 15 are provided, which are arranged at a spacing to extend substantially parallel to one another. In that case, the ends of the straps 15 are respectively fastened to the cage roof 12 at opposite sides of the opening. The cage roof part 13.1 is respectively suspended in a loop of the straps 15. The actually selected path of the straps 15 in relation to the cage roof part 13.1 can differ from the parallel arrangement. An oblique course of the straps 15 relative to one another with or without crossing-over is equally possible.

Alternatively to suspension of the cage roof part 13.1 in a loop of a safety element 15 the cage roof part 13.1 can also be suspended at an end of a safety element 15. In such an embodiment the four corners of the cage roof part 13.1 are each suspended at a first end of a safety element 15. The second end of the respective safety element 15 is fastened to the cage roof 12.

The safety element 15 holds the cage roof part 13 at a predeterminable height with respect to the interior of the lift cage 11 even after release of the connections of the retaining elements 14. It is thus ensured that the cage roof part 13.1 does not drop onto and possibly injure passengers already present in the cage 11.

In a rest position of the cage roof part 13.1, i.e. when the cage roof part 13.1 is fixed by the retaining elements 14 to the cage roof 12, a safety element 15 is in an unloaded state. Correspondingly, a part of the safety element 15 lies as a loop on the cage roof part 13.1. In operation of lift installation 20 vibrations can arise which are transmitted to these loops. This can lead to an additional operating force acting on the cage roof part 13.1. This is disadvantageous insofar as this additional force action can lead to a spontaneous undesired release of the connections to the retaining elements 14.

This negative effect is avoidable in that a freely resting loop is fixed to the cage roof part 13.1 by means of a split-pin 18 or another suitable fastening element. Alternatively thereto this loop is also fastenable to the cage roof 12. This slip-pin 18 is so fastened to the cage roof part 13.1 or the cage roof 12 that after release of the connections to the retaining elements 14 a respective split-pin 18 is pulled out of its fastening, when the cage roof part 13.1 drops down into the interior space of the cage 11, and thus releases the safety element 15.

According to FIG. 2a the loop of the safety element 15 at which the cage roof part 13.1 hangs is coverable from below by a dummy cover 13.2. The safety element 15 is thus not visible from the interior of the cage 11 and an attractive appearance is ensured. In addition, the dummy cover 13.2 protects the straps 15 from vandalism. The dummy cover 13.2 is preferably fastened to the cage roof part 13.1 by means of screw connections 17 or other suitable fastening elements.

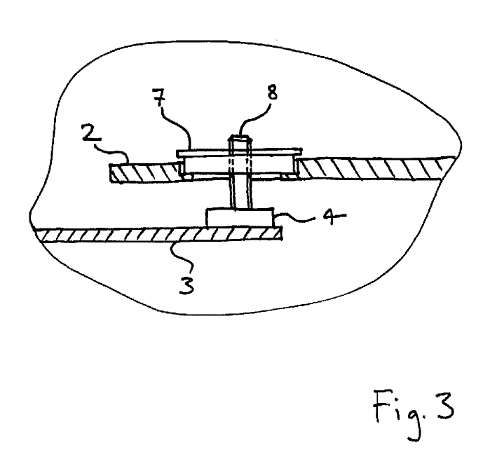

FIG. 3 shows a detail view of a suspension of a retaining element 4 at the cage roof 2. In this variant of embodiment the retaining element 4 is arranged to be adjustable in height relative to the cage roof 2 by means of a setting screw 8 and a setting nut 7. A recess in the cage roof 2 serves as a bearing, on which the setting nut rests, for the setting nut 7. The setting screw 8 is on the one hand connected with the retaining element 4 and on the other hand screw-connected by way of the thread of the setting nut 7 with this. The relative height of the retaining element 4 or of the cage roof part 3, which is suspended thereat, with respect to the cage roof 3 is adjustable by rotation of the setting nut 7 and the thereby constrained vertical displacement of the setting screw 8.

The suspension according to FIG. 3 is usable in both embodiments of FIGS. 1a, 1b and FIGS. 2a, 2b.

A catch net can be arranged, optionally with respect to the embodiments in FIGS. 1, 2a and 2b, on the upper side of the cage roof 2, 12. The catch net preferably covers substantially at least the cage roof part 3, 13.1. The catch net is in that case fastened at its extremities to the cage 1, 11 or cage roof 2, 12 in such a manner that the catch net does not drop a person, who walks onto the cage roof part 3, 13.1, into the interior of the cage 2, 12 notwithstanding yielding of the cage roof part 3, 13.1. For that purpose the mesh width of the catch net is preferably selected to be of such fineness that at least a foot is prevented from passing through a mesh. For reasons of clarity the catch net is not illustrated in FIGS. 1, 2a and 2b.

1. Lift installation (10; 20) with
a cage (1; 11) and
a cage roof (2; 12), which comprises at least a cage roof part (3; 13.1) which covers an opening of the cage roof (2; 12) and is suspended by at least one retaining element (4; 14),
characterised in that the retaining element (4; 14) exerts on the cage roof part (3; 13.1) a magnetic force which is at least equal to the weight force of the cage roof part (3; 13.1).

2. Lift installation (10; 20) according to claim 1, characterised in that the retaining element (4; 14) forms a releasable connection between the cage roof (2; 12) and the cage roof part (3; 13.1), wherein the connection releases from a predeterminable critical release force which acts on the cage roof part (3; 13.1) from above the cage roof (2; 12).

3. Lift installation (10; 20) according to claim 2, characterised in that the predeterminable critical release force is at most 300 N.

4. Lift installation (10; 20) according to claim 1, characterised in that the cage roof part (3; 13.1) is of multi-part design.

5. Lift installation (10; 20) according to claim 4, characterised in that the cage roof part (3; 13.1) is of at least two-part design from a plan area of 2 square metres.

6. Lift installation (10; 20) according to claim 1, characterised in that the retaining element (4; 14) is designed as a magnetic strip.

7. Lift installation according to claim 1, characterised in that the retaining element (4; 14) is designed as a magnetic element.

8. Lift installation according to claim 1, characterised in that the retaining element (4; 14) is arranged at the cage roof (2; 12) to be adjustable in height by means of a setting element.

9. Lift installation (20) according to claim 1, characterised in that at least one safety element (15) is provided which connects the cage roof part (13.1) with the cage roof (12) and holds the cage roof part (13.1) at a predeterminable minimum height relative to the interior space of the cage (11) after release of the connection.

10. Lift installation (20) according to claim 9, characterised in that the safety element (15) is designed as a strap.

11. Lift installation (20) according to claim 9, characterised in that the ends of the safety element (15) are fastened to the cage roof (12) and the cage roof part (13.1) hangs in a loop of the safety element (15).

12. Lift installation (20) according to claim 1, characterised in that a catch net is so arranged on the cage roof (2; 12) that by means of this a person who steps onto the cage roof part (3; 13.1) can be caught and can be prevented from falling into the cage (1; 11).
